(19) United States
(12) Patent Application Publication
(10) Pub. No.: US 2021/0116069 A1
(43) Pub. Date: Apr. 22, 2021

(54) Grease Gun Coupler

(71) Applicant: Univer-co (2013) Inc., Napierville (CA)

(72) Inventors: Alain Bisaillon, Napierville (CA); Richard Labelle, Delson (CA)

(21) Appl. No.: 17/047,538

(22) PCT Filed: Apr. 16, 2019
(86) PCT No.: PCT/CA2019/000048

§ 371 Date: Oct. 14, 2020

Related U.S. Application Data
(60) Provisional application No. 62/659,401, filed on Apr. 18, 2018.

(51) Int. Cl. F16N 21/04; F16L 37/127

(52) U.S. Cl. CPC F16N 21/04; F16L 37/127

(57) ABSTRACT

A grease gun coupler is adapted to receive grease fittings of different sizes by having an inner sleeve, an outer sleeve slidably mounted about the inner sleeve and a gripping element between the inner and outer sleeve that is in the form of a hollow cylinder made of a plurality of sectors, each having an outwardly movable distal end that forms together at the distal end of the hollow cylinder an inwardly projecting rim that is movable between a first position, that yields a widened opening to receive a grease fitting head, and a second position, that yields a narrow opening configured to grip unto the grease fitting head.

### FIELD

The present invention generally relates to grease guns, more specifically to a grease gun coupler for firmly securing to common grease fittings of different shapes and sizes.

### BACKGROUND

Grease guns are commonly used to apply lubricant through an aperture to a specific point, usually on a grease fitting. Grease guns can be hand-powered or air-powered and can be loaded with any of the various types of lubricants, such as thick grease.

Grease fittings, also called grease nipples, Zerk fittings, and Alemite fittings are metal fittings permanently installed by a threaded connection, leaving a nipple connection that receives the grease gun. The pressure supplied by the grease gun forces a small captive ball bearing in the nipple to move back against the force of its retaining spring to allow lubricant to pass. The ball returns to its closed position when the pressure ceases.

Grease gun couplers are devices that couple the tube of a grease gun to a grease fitting. Conventional couplers use legs to attach themselves to these fittings. However, such couplers wear out quickly because of the way they engage to and disengage from the grease fittings. Slightly worn couplers rapidly cease to hold on to the grease fittings as they should. Another disadvantage of these couplers is that the operator needs to carefully align the coupler on the grease fitting to have a proper connection. As a result of all this, grease leakages at the coupler/fitting junction are quite common.

United States Patent Publication no. US 2015/0115601 A1, published on Apr. 30, 2015, naming Boucher et al. as the inventors and being titled “Grease Gun Coupler” describes a grease gun coupler that aims at solving the above-described drawbacks. This coupler is provided with a ball bearing arrangement at the distal end of an inner sleeve, about a grease fitting receiving head, which is forced to grip unto the grease fitting when an outer sleeve is released onto the ball bearing arrangement.

A drawback of this coupler from Boucher et al. is that it can only be tightly coupled to grease fittings having a specific configuration and size due to the limitation of the ball bearings used.

### SUMMARY

The problem of the limited accommodating size of the fitting head of common grease gun coupler is solved by providing a grease gun coupler having an inner sleeve, an outer sleeve slidably mounted about the inner sleeve and a gripping element between the inner and outer sleeve that is in the form of a hollow cylinder made of a plurality of sectors, each having an outwardly movable distal end that forms together at the distal end of the hollow cylinder an inwardly projecting rim that is movable between a first position, that yields a widened opening to receive a grease fitting head, and a second position, that yields a narrow opening configured to grip unto the grease fitting head.

According to an illustrative embodiment, there is provided a grease gun coupler comprising:

an inner sleeve, that defines a longitudinal axis, having proximate and distal ends and defining an opening of the grease gun coupler at the distal end thereof;

a socket removably mounted to the inner sleeve at the proximate end thereof;

an outer sleeve, having proximate and distal ends, that is coaxially mounted about the inner sleeve for relative sliding movement therebetween;

a first biasing member mounted to both inner and outer sleeves therebetween for biasing the outer sleeve away from the socket wherein the outer sleeve is in a neutral position;

a piston having a distal end that defines a grease fitting head housing; the piston being mounted in the inner sleeve in a snugly fit manner for slidable movement therein between a first position wherein the piston is completely withdrawn within the inner sleeve to a second position, wherein the piston partially extends out of the inner sleeve;

a second biasing member mounted in the inner sleeve between the socket and piston for biasing the piston away from the socket towards its second position; and

a gripping element having a hollow cylindrical shape, proximate and distal ends and an inwardly projecting rim at the distal end; the gripping element being formed by a plurality of sectors mounted to the inner sleeve between the inner and outer sleeves, so that the inwardly projecting rim i) is forced to partially close the opening of the grease gun coupler by the outer sleeve when the outer sleeve is in its neutral position, thereby locking a grease fitting head pushed in the opening of the grease gun coupler, and ii) is outwardly movable radially so as to free the opening of the grease gun coupler when the outer sleeve is slid away from its neutral position, thereby allowing the piston to be moved to its second position by the second biasing member, and the grease fitting head to be inserted in the opening of the grease gun coupler or withdrawn therefrom.

According to another illustrative embodiment, there is provided a grease gun coupler comprising:

an inner sleeve;

an outer sleeve slidably mounted about the inner sleeve; and

a gripping element mounted to the inner sleeve between the inner and outer sleeve; the gripping element being in the form of a hollow cylinder, made of a plurality of sectors each having an outwardly movable distal end that form together at the distal end of the hollow cylinder an inwardly projecting rim that is movable between a first position that yields a widened opening to receive a grease fitting head therethrough and a second position that yields a smaller opening than the widened opening that is configured to grip onto the grease fitting head.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise specifically noted, articles depicted in the drawings are not necessarily drawn to scale.

### BRIEF DESCRIPTION OF THE DRAWINGS

In the appended drawings:

FIG. 1 is a perspective view of a grease gun coupler according to a first illustrated embodiment; the grease gun coupler being shown engaged with a grease fitting;

FIG. 2 is a cross-sectional perspective view taken along lines 2-2 in FIG. 1;

FIG. 3 is a front elevation of the grease gun coupler from FIG. 1;

FIG. 4 is cross-sectional view taken from lines 4-4 in FIG. 3, showing the grease gun coupler engaged with the grease fitting;

FIG. 5 is a cross-sectional view similar to FIG. 4, showing the grease gun coupler released from the grease fitting;

FIG. 6 is an isolated exploded view illustrating the mounting of the gripping element on the inner sleeve of the grease gun coupler from FIG. 1;

FIG. 7 is a perspective view of a grease gun coupler according to a second illustrated embodiment; the grease gun coupler being shown engaged with a grease fitting;

FIG. 8 is a cross-sectional perspective view taken along lines 8-8 in FIG. 7;

FIG. 9 is a front elevation of the grease gun coupler from FIG. 7;

FIG. 10 is cross-sectional view taken from lines 10-10 in FIG. 9, showing the grease gun coupler engaged with the grease fitting;

FIG. 11 is a cross-sectional view similar to FIG. 10, showing the grease gun coupler released from the grease fitting;

FIG. 12 is an isolated exploded view illustrating the mounting of the gripping element on the inner sleeve of the grease gun coupler from FIG. 7; and

FIG. 13 is a perspective view of a grease gun coupler according to a third illustrative embodiment.

### DETAILED DESCRIPTION

In the following description, similar features in the drawings have been given similar reference numerals, and in order not to weigh down the figures, some elements are not referred to in some figures if they were already identified in a precedent figure. Herein, it shall further be noted that, for avoiding unnecessary details obscuring the invention, only device structures and/or processing steps closely relevant to schemes according to the invention are shown in the accompanying drawings while omitting other details less relevant to the invention.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, un-recited elements.

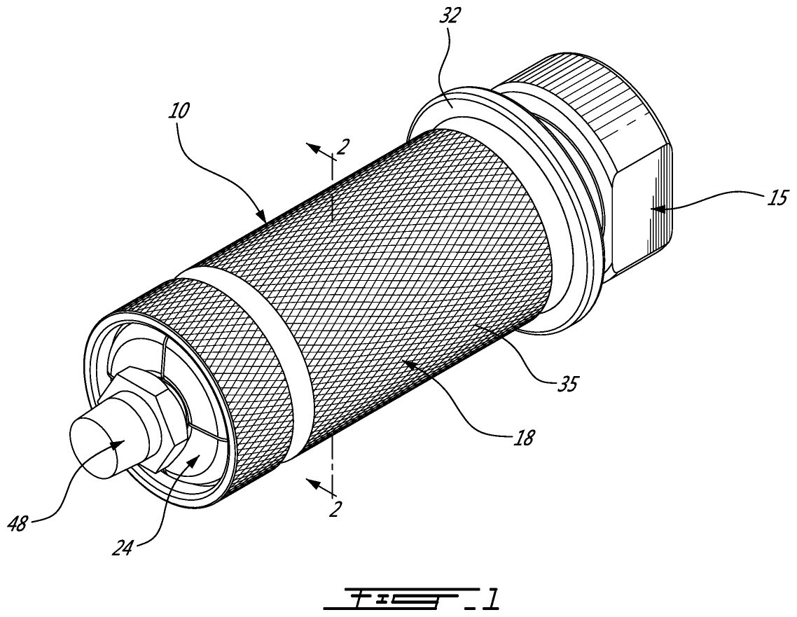

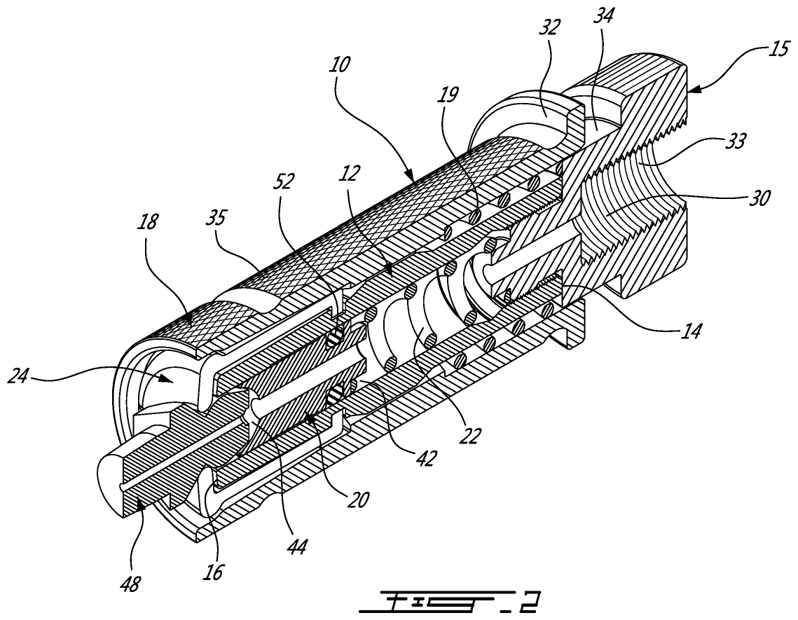

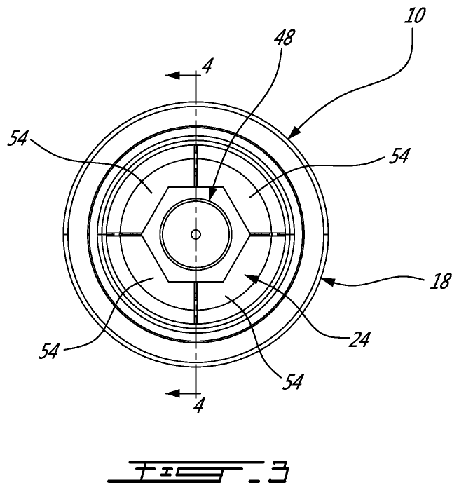

An illustrated embodiment of a grease gun coupler 10 will now be described with reference to FIGS. 1 to 5.

The coupler 10 comprises a cylindrical inner sleeve 12, defining a longitudinal axis 13 and having proximate and distal longitudinal ends 14-16, a socket 15 screwed into the inner sleeve 12 at the proximate end 14 thereof, an outer sleeve 18 that is coaxially mounted about the inner sleeve 12 for relative sliding movement, a first biasing member 19 mounted to both sleeves 12 and 18 therebetween for biasing the outer sleeve 18 away from the socket 15, a piston 20 mounted in the inner sleeve 12 in a snugly fit manner for slidable movement therein, a second biasing member 22 mounted in the inner sleeve 12 between the socket 15 and piston 20 for biasing the piston 20 away from the socket 15, and a gripping element 24 that is mounted to the inner sleeve 12 between the sleeves 12 and 18 near both distal end thereof.

According to the illustrated embodiment, both biasing members 19 and 22 are compression springs.

The socket 15 includes a wider coupling portion 26 for attachment to the tube of a grease gun (not shown), a narrower portion 28 that is inserted in the inner sleeve 12, and a middle portion 34 therebetween, defining a shoulder portion 27. The socket 15 includes a two section bore 30 which allows passage for grease from the grease gun to the interior of the inner sleeve 12.

The wider portion 26 is generally configured for coupling to the grease gun and, for such a purpose, includes coupling elements, such as threads 33 in the wider section of the bore 30. The narrower portion 28 also includes threads 31 for cooperation with complementary threads 31′ in the inner sleeve 12 at the proximate end 14 thereof.

The socket 15 is not limited to the illustrated embodiment and can be adapted for different grease guns. For example, other coupling elements than threads can be used to attach the socket 15 to a grease gun and or to the inner sleeve 12. According to another embodiment (not shown), the socket 15 and inner sleeve 12 are integral.

The outer sleeve 18 includes a flange 32 that provides a grip on the sleeve 18 to ease its manual moving towards the socket 15. The shoulder portion 27 of the socket 15 defines a mechanical stop for the flange 32 when it is moved towards the socket 15. The outer surface of the sleeve 18 also includes a textured portion, such as knurled surface 35. The inner diameter of the sleeve 18 is similar to the outer diameter of the middle portion 34 of the socket 15 so that the sleeve 18 is mounted on such portion 34 in a snuggly fit manner.

The inner surface of the outer sleeve 18 includes a narrower section 36 which defines a shoulder portion 38 facing the socket 15. The shoulder portion 38 defines a mechanical stop that confines the biasing member 19 around a portion of the inner sleeve 12 near the proximate end thereof 14. The biasing member 19 is prevented from exited the outer sleeve 18 by the socket 15.

According to another embodiment (not shown), the shoulder portion 38 is omitted and the end of the biasing member 19 opposite the socket 15 is stopped by an enlarged portion of the inner sleeve 12.

It is to be noted that the position of the outer sleeve 18 wherein it is farthest from the socket 15 will be referred to herein as the neutral position of the outer sleeve 18.

The inner section of the outer sleeve 18 between the distal end 40 thereof and the narrow section 36 is tapered so as to define a housing for the gripping element 24 and so as to facilitate the movement thereof partially in and out of the outer sleeve 18 as will be explained hereinbelow in more detail.

The piston 20 is bored along the longitudinal axis 13, which allows passage for the grease when the coupler 10 is in use. The piston 20 is mounted in the inner sleeve 12 in a snuggly fit manner between the distal end 16 thereof and the second biasing member 22.

The proximate end of the piston 20 has a smaller diameter, which defines, therearound, a receiving seat 42 for the biasing member 22.

The distal end of the piston 20 is provided with a hemispherical recess 44, which defines a housing for the head 46 of a grease fitting 48 and which is adapted for different sizes and shapes thereof. According to another embodiment, the grease fitting head 46 is differently configured.

The piston 20 also includes an annular groove 50, that receives an O-ring 52 that seals the space between the piston 20 and inner sleeve 12.

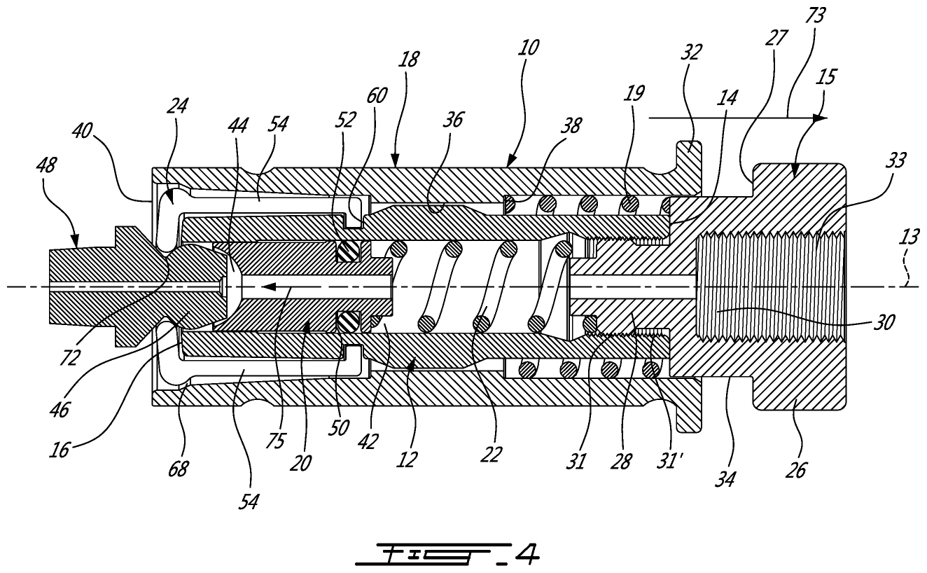

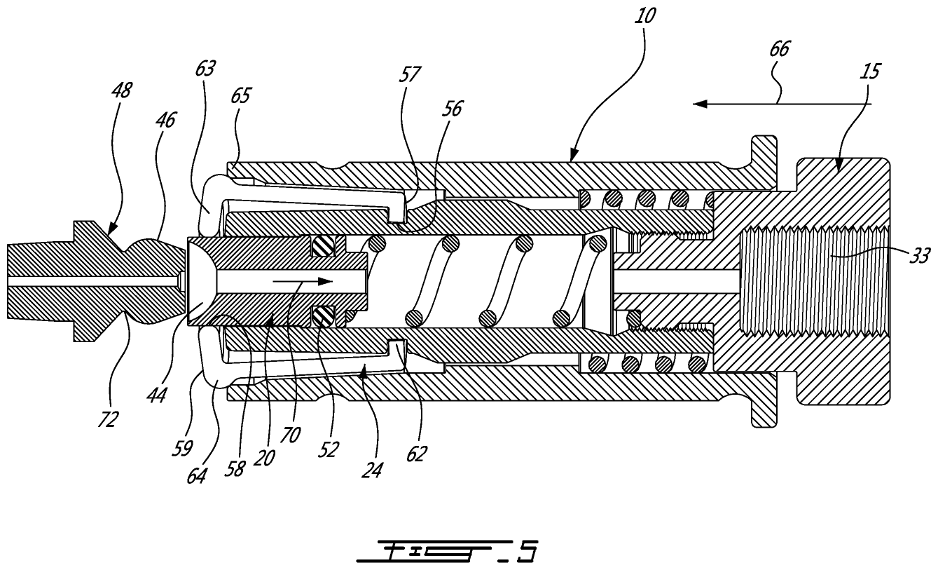

In operation, the piston 20 is movable within the inner sleeve 12 between a retracted position, wherein the piston 20 is completely withdrawn within the inner sleeve 12 (see FIG. 4) to an extended position, wherein the piston 20 partially extends out of the inner sleeve 12 (see FIG. 5).

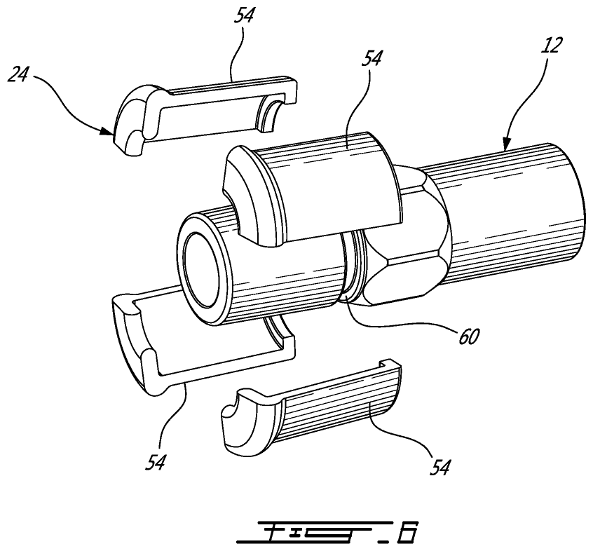

With reference more specifically to FIG. 6, the gripping element 24 is made of four (4) identical detached sectors 54 of the piece 24, that are joined between the inner and outer sleeves 12 and 18 near the distal ends 16 and 40 thereof to form and expandable hollow cylinder having apertures 56 and 58 respectively at its proximate and distal end sides 57 and 59 (see on FIG. 5).

The hollow cylinder 24 includes first and second radially inwardly projecting rims 62 and 63 respectively at the proximate and distal ends 57 and 59 thereof. The cylinder 24 further includes a rounded outer collar 64 at its distal end 59.

The outer surface of the inner sleeve 12 includes an annular groove 60 that receives the rim portion 62 of each piece 54, thereby preventing axial movement of the gripping element 24 relative to the inner sleeve 12.

The outer sleeve 18 includes a thinning 65 of its wall at its distal end 40 to further facilitate the passage of the gripping element 24 in and out of the sleeve 18 when the sleeve 18 is moved towards the socket 15.

Other characteristics and features of the grease gun coupler 10 will now be described with reference to the operation thereof with reference to FIGS. 4 and 5.

FIG. 5 illustrates the position of the grease gun coupler 10 in an uncoupled position to a grease fitting 48.

To insert a grease fitting 48 in the coupler 10, the grease fitting 48 is simply pushed onto the recess 44 of the piston 20 with a force sufficient to overcome the biasing force of the spring 22. This is achieved while the socket 15, or a grease gun hose connected thereto (not shown), is held. This causes the piston 22 to move towards the socket 15 (see arrow 70) while the fitting 48 moves through the opening defined by the rim 63. The forward movement of the fitting 48 is stopped when the collar portion 72 of the fitting 48 reaches the rim 63. The depression defined by the collar 72 causes the rim 63 to move inwardly freeing the opening of the outer sleeve 18 which is then free to slide away from the socket 15 (see arrow 66). The grease gun coupler 10 is then in the position shown in FIG. 4.

The inner surface of the sleeve 18 is provided with an annular ring 68 which causes the sleeve 18 to exert pressure onto the gripping element 24 when a grease fitting 48 is inserted in the coupler 10, thereby biasing the quarter pieces 54 of the gripping element 24 towards one another. This contributes to preventing the inadvertent withdrawal of the fitting 48 out of the coupler 10.

To release the fitting 48 from the coupler 10, the coupler 10 is moved from the position shown in FIG. 4 to the position shown in FIG. 5. With reference to FIG. 4, this is achieved first by sliding the outer sleeve 18 towards the wider portion 26 of the socket 15 (see arrow 73 on FIG. 4). The inner sleeve 12 being fixedly mounted to the socket 15 and the rim portion 62 of the gripping element 24 being fixedly mounted to the inner sleeve 12, this sliding movement of the outer sleeve 18 causes the distal end thereof 40 to be withdrawn from about the rim 63, removing any pressure thereon. The rim 63 of the gripping element 24 is then free to outwardly move radially, allowing the piston 20 to exit the inner sleeve 12 through the widened opening defined by the rim 43 under the biasing force of the spring 2 (see arrow 75).

The rim 63 being rounded facilitate the radially outward movement of the rim 43 under the pushing force of the piston 20.

It is to be noted that many modifications could be made to the grease gun coupler 10 described hereinabove and illustrated in the appended drawings. For example:
other biasing members than compression springs can be used;
the piston 20 is not limited to the illustrated configuration. For example, the section of the piston 20 and/or the corresponding inner portion of the inner sleeve 12 can be cylindrical, hexagonal, etc. Also, another sealing member than the O-ring 52 can be provided;
the configurations and sizes of the inner and outer sleeves can also be different than illustrated;
the gripping member 24 is not limited to being formed by four identical parts 54. A different number of sectors can alternatively be provided. Also, the slits separating the cylinder 24 into sectors are not limited to be straight.

According to still another embodiment, the gripping element is a frustoconically shaped cylinder having longitudinal slits therein (not shown), each extending partially along the length of the body so as to allow the gripping element to be movable from an inwardly compressed position when the outer sleeve 18 is in its neutral position to a neutral position when the outer sleeve is moved away from its neutral position.

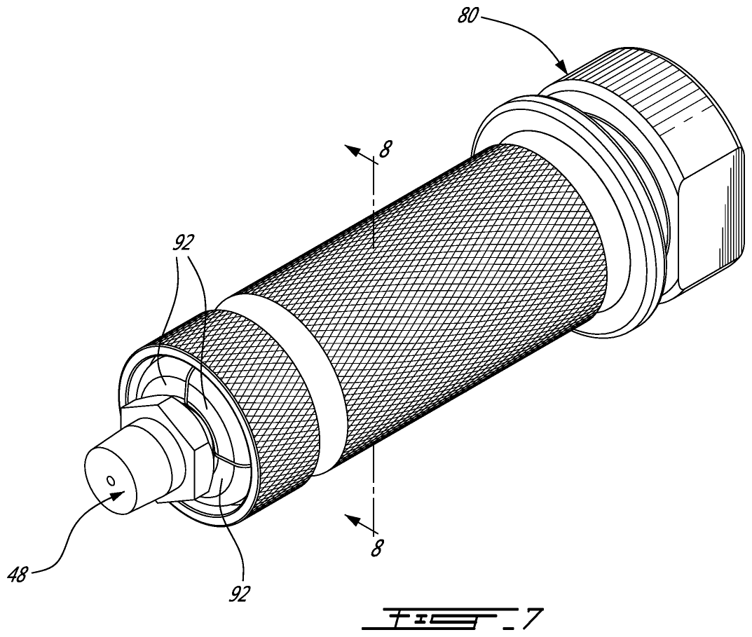

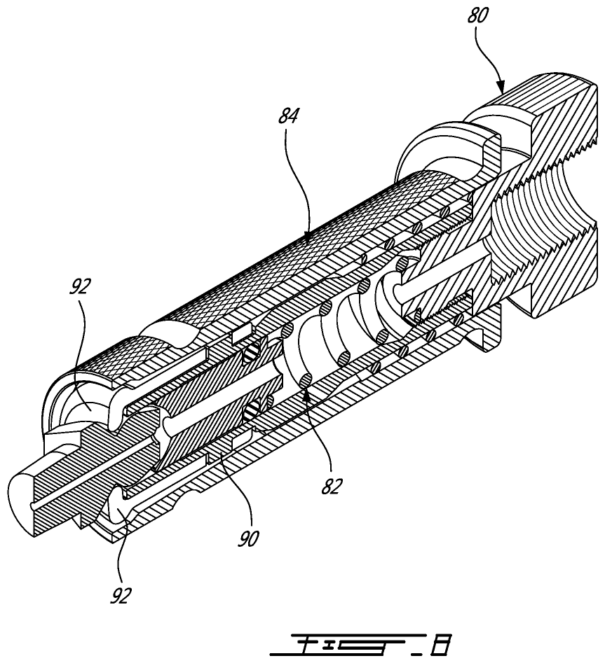

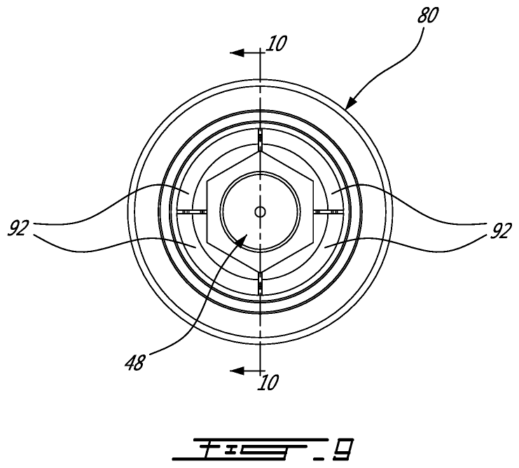

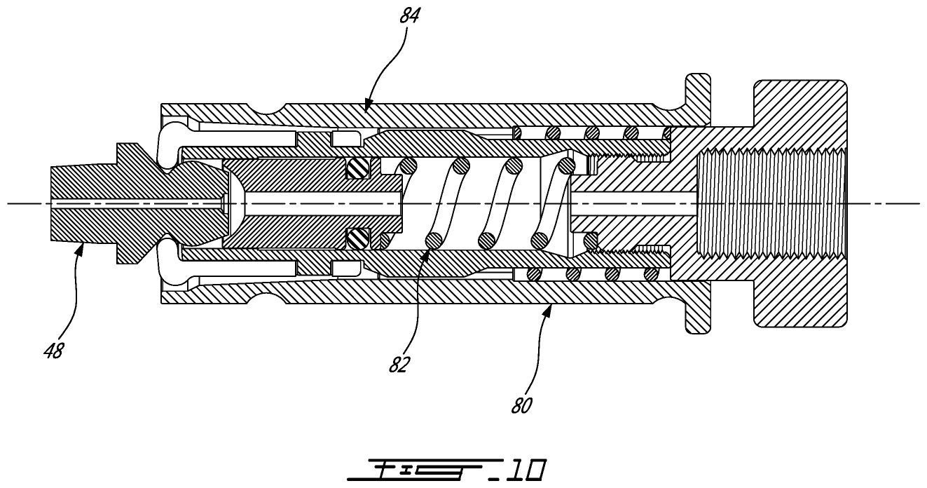

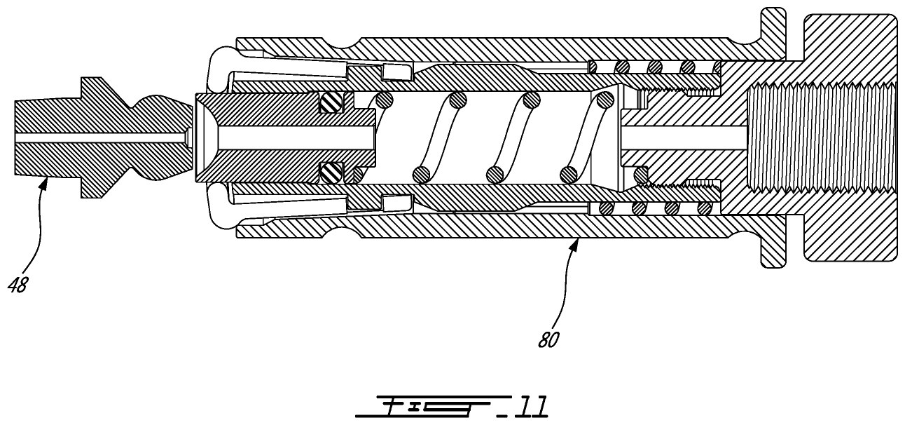

A grease gun coupler 80 according to a second illustrative embodiment will now be described with references to FIGS. 7 to 12. Since the coupler 80 is similar to the coupler 10, only the differences therebetween will be described herein in more detail for concision purposes.

The grease gun coupler 80 is narrower than the grease coupler 10, mainly due to the inner and outer sleeve thereof 82 and 84 being narrower.

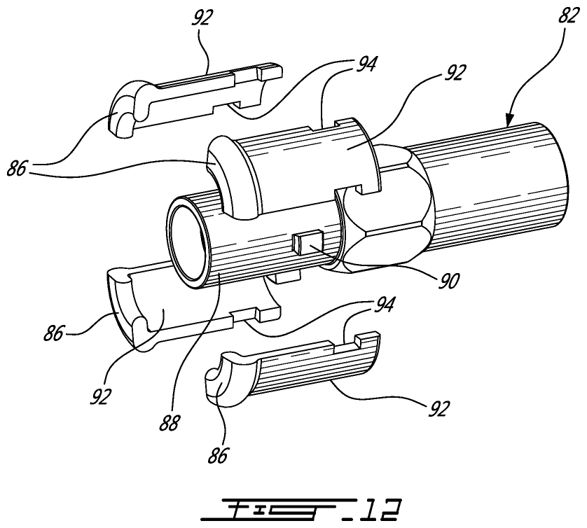

With reference to FIG. 12, the inner sleeve 82 and gripping element 86 of the grease gun coupler 80 will now be described.

The portion 88 of the inner sleeve 82 that is registered with the gripping element 86 includes four (4) rectangular protrusions 90 that are longitudinally registered and equidistantly disposed radially.

Compared to the gripping element 24, the cylindrical gripping element 86, which is similarly formed of four sectors 92, does not include a rim at its proximate end. Each of the four sectors 92 includes a pair of longitudinally lateral side notches 94. When the sectors 92 are laterally joined to form a cylinder about the portion 88, the notches 94 form rectangular openings in the cylinder, each receiving a respective protrusion 90, locking in place the longitudinal position of the gripping element 86 relative to the inner sleeve 82.

The operation of the grease gun coupler 80 is identical to the operation of the grease gun coupler 10.

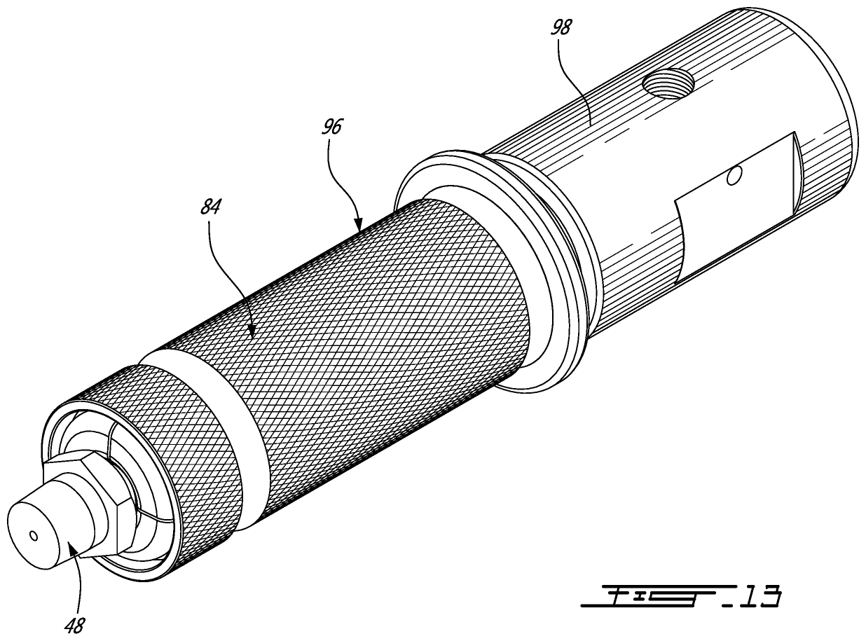

FIG. 13 shows a grease gun coupler 96 according to a third illustrative embodiment which differs from the coupler 80 by its socket 98, which is longer and includes a transversal opening 99 in fluid communication with its central bore for receiving a pressure release valve (not shown).

Since the use of such a valve on a grease gun coupler is believed to be well-known in the art, it will not be described herein in more detail for concision purposes.

Although a grease gun coupler has been described hereinabove by way of illustrated embodiments thereof, it can be modified. It is therefore to be understood that numerous modifications may be made to the illustrative embodiments and that the scope of the claims should not be limited by the thereby but should be given the broadest interpretation consistent with the description as a whole.

What is claimed is:

1. A grease gun coupler comprising:
an inner sleeve, that defines a longitudinal axis, having proximate and distal ends and defining an opening of the grease gun coupler at the distal end thereof;
a socket removably mounted to the inner sleeve at the proximate end thereof;
an outer sleeve, having proximate and distal ends, that is coaxially mounted about the inner sleeve for relative sliding movement therebetween;
a first biasing member mounted to both inner and outer sleeves therebetween for biasing the outer sleeve away from the socket wherein the outer sleeve is in a neutral position;
a piston having a distal end that defines a grease fitting head housing; the piston being mounted in the inner sleeve in a snugly fit manner for slidable movement therein between a first position wherein the piston is completely withdrawn within the inner sleeve to a second position, wherein the piston partially extends out of the inner sleeve;
a second biasing member mounted in the inner sleeve between the socket and piston for biasing the piston away from the socket towards its second position; and
a gripping element having a hollow cylindrical shape, proximate and distal ends and an inwardly projecting rim at the distal end; the gripping element being formed by a plurality of sectors mounted to the inner sleeve between the inner and outer sleeves, so that the inwardly projecting rim i) is forced to partially close the opening of the grease gun coupler by the outer sleeve when the outer sleeve is in its neutral position, thereby locking a grease fitting head pushed in the opening of the grease gun coupler, and ii) is outwardly movable radially so as to free the opening of the grease gun coupler when the outer sleeve is slid away from its neutral position, thereby allowing the piston to be moved to its second position by the second biasing member, and the grease fitting head to be inserted in the opening of the grease gun coupler or withdrawn therefrom.

2. The grease gun coupler as recited in claim 1, wherein a portion of the inner sleeve that is registered with the gripping element includes protrusions; the gripping element including openings that cooperate with the protrusions to prevent the gripping element from moving axially relative to the inner sleeve.

3. The grease gun coupler as recited in claim 1, wherein the inwardly projecting rim of the gripping element is a first inwardly projecting rim; the inner sleeve including an annular groove; the gripping element including a second inwardly projecting rim at the distal end thereof that is inserted in the annular groove of the inner sleeve so as to prevent the gripping element from moving axially relative to the inner sleeve.

4. The grease gun coupler as recited in claim 1, wherein the sectors of the gripping element are individual pieces.

5. The grease gun coupler as recited in claim 1, wherein the plurality of sectors of the gripping element includes four sectors.

6. The grease gun coupler as recited in claim 1, wherein the outer sleeve has an inner wall provided with a thinning at the distal end thereof to facilitate a passage of the gripping element when the outer sleeve is slid away from its neutral position.

7. The grease gun coupler as recited in claim 1, wherein the outer sleeve has an inner wall provided with an annular ring at the distal end thereof that exerts pressure onto the gripping element when the outer sleeve is in the neutral position.

8. The grease gun coupler as recited in claim 1, wherein the distal end of the gripping element is rounded.

9. The grease gun coupler as recited in claim 1, wherein the grease fitting head housing is hemispherical in shape.

10. The grease gun coupler as recited in claim 1, wherein the piston has a smaller diameter at a proximate end thereof that defines a seat for the second biasing member.

11. The grease gun coupler as recited in claim 1, wherein the piston includes an annular groove that receives an O-ring.

12. The grease gun coupler as recited in claim 1, wherein the socket includes a shoulder portion that defines a mechanical stop for the outer sleeve when the outer sleeve is moved away from the neutral position towards the socket.

13. The grease gun coupler as recited in claim 1, wherein the socket includes a transversal opening in fluid communication with its central bore to receive a pressure release valve.

14. The grease gun coupler as recited in claim 1, wherein at least one of the first and second biasing members is a spring.

15. A grease gun coupler comprising:
an inner sleeve;
an outer sleeve slidably mounted about the inner sleeve; and
a gripping element mounted to the inner sleeve between the inner and outer sleeve; the gripping element being in the form of a hollow cylinder, made of a plurality of sectors each having an outwardly movable distal end that form together at the distal end of the hollow cylinder an inwardly projecting rim that is movable between a first position that yields a widened opening to receive a grease fitting head therethrough and a second position that yields a smaller opening than the widened opening that is configured to grip onto the grease fitting head.
